(19) United States
(12) Patent Application Publication
(10) Pub. No.: US 2009/0302223 A1
(43) Pub. Date: Dec. 10, 2009

(54) METHOD OF MEASURING TERAHERTZ WAVE AND TERAHERTZ SPECTROSCOPIC APPARATUS

(75) Inventors: Sakuya Tamada, Tokyo (JP); Kazumine Ito, Tokyo (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/481,140

(22) Filed: Jun. 9, 2009

(30) Foreign Application Priority Data
Jun. 10, 2008 (JP) 2008-152047

(51) Int. Cl. G01J 5/02; G01J 5/00

(52) U.S. Cl. 250/340; 250/338.1

(57) ABSTRACT

A method of measuring a terahertz wave includes the steps of: starting input of a pulse signal showing that scale marks have been detected, which are arranged at equal intervals along a moving direction of a movable stage which can move in a direction in which an optical path length of incident pulse light is contracted or extended; and taking signals outputted at pulse intervals of the pulse light from a terahertz wave detecting section by synchronizing the timing with the pulse signal.

### BACKGROUND OF THE INVENTION

1. Field of the Invention

The present invention relates to a technique using an electromagnetic wave (terahertz wave) in a band from approximately 0.1×10¹² [Hz] to 100×10¹² [Hz].

2. Description of the Related Art

In related art, there exists a terahertz time-domain spectroscopy (THz-TDS) as a spectroscopic techniques of terahertz waves. It is known that the terahertz time-domain spectroscopy is suitable for sample imaging, therefore, the spectroscopy receives attention in various technological fields such as industry, medical services, biotechnology, agriculture and security.

In the terahertz time-domain spectroscopy, pulse light from an ultra-short laser light source is divided into a pumping light and a probe light, and the pumping light is condensed at a terahertz wave generating section. According to this, electric current or electric polarization of approximately a subpicosecond is generated at the terahertz wave generating section and a terahertz wave having an electric field amplitude which is in proportion to the time differential of the current is generated. The terahertz wave is transmitted through the measurement sample or reflected by the measurement sample through an optical system, then, condensed at a terahertz wave detecting section. At this time, when the probe light is irradiated at the terahertz wave detecting section, a carrier is generated and accelerated by an electric field of the terahertz wave to generate current, which will be a pulsed electric signal. The timing at which the probe light reaches the terahertz wave detecting section is shifted, thereby measuring time wavelength of amplitude electric field of a terahertz wave, and the Fourier transform is performed on the time wavelength, thereby obtaining a transmission or a reflection spectrum in the terahertz-wave band.

As a spectroscopic apparatus to which the terahertz time-domain spectroscopy is applied, the one including a delay stage which performs time delay of one of pulse lights divided into two by a beam splitter, a position measuring means for measuring a position of the delay stage and a means for correcting a detection signal which shows time variation of the electric-field strength in a terahertz wave based on a signal outputted from the position measuring means is proposed (for example, refer to JP-A-2007-1013070 (Patent Document 1)).

In the spectroscopic apparatus, an accurate spectrum can be obtained by using a given algorithm concerning correction of a detection signal even when positioning accuracy of the delay stage is low.

### SUMMARY OF THE INVENTION

However, in Patent Document 1, there is a problem that measurement accuracy depends on a correction algorithm to be applied.

It is desirable to propose a method of measuring a terahertz wave and a terahertz spectroscopic apparatus which can improve measurement accuracy.

A method of measuring a terahertz wave according to an embodiment of the invention includes the steps of starting input of a pulse signal showing that scale marks have been detected, which are arranged at equal intervals along a moving direction of a movable stage which can move in a direction in which an optical path length of incident pulse light is contracted or extended and taking signals outputted at pulse intervals of the pulse light from a terahertz wave detecting section by synchronizing the timing with the pulse signal.

A terahertz spectroscopic apparatus according to an embodiment of the invention includes a return mirror returning incident pulse light, a movable stage in which the return mirror is disposed, which can move in a direction in which an optical path length of the pulse light is contracted or extended, a detecting section detecting scale marks arranged at equal intervals along a moving direction of the movable stage and outputting a pulse signal showing that the scale marks have been detected and a signal taking section taking signals outputted at pulse intervals of the pulse light from the terahertz wave detecting section by synchronizing the timing with the pulse signal.

According to the embodiments of the invention, when the movable stage is moved, the detection signal is taken in the terahertz wave detecting section every time the scale mark is detected in accordance with the movement, therefore, sampling intervals with respect to the terahertz waveform can be fixed regardless of moving speed of the stage, which realizes the method of measuring a terahertz wave and the terahertz spectroscopic apparatus which can improve measurement accuracy of the terahertz waveform without correction with respect to change of moving speed of the movable stage.

### BRIEF DESCRIPTION OF THE DRAWINGS

FIG. 1 is a schematic diagram showing the whole configuration of a terahertz spectroscopic apparatus;

FIG. 2 is an outlined view showing a configuration (1) of a time delay section;

FIG. 3 is an outlined view showing a configuration (2) of a time delay section;

FIG. 4 is a schematic diagram showing a configuration of a computer;

FIG. 5 is a flowchart showing a measurement processing procedure;

FIG. 6 is an outlined view showing relation between a scale detection pulse and sampling intervals of terahertz waveform; and

FIG. 7 is an outlined view showing relation between an internal clock and sampling intervals of terahertz waveform in related art.

### DETAILED DESCRIPTION OF THE INVENTION

Hereinafter, an embodiment of the invention will be described in detail with reference to the drawings.

### (1) Whole Configuration of Terahertz Spectroscopic Apparatus

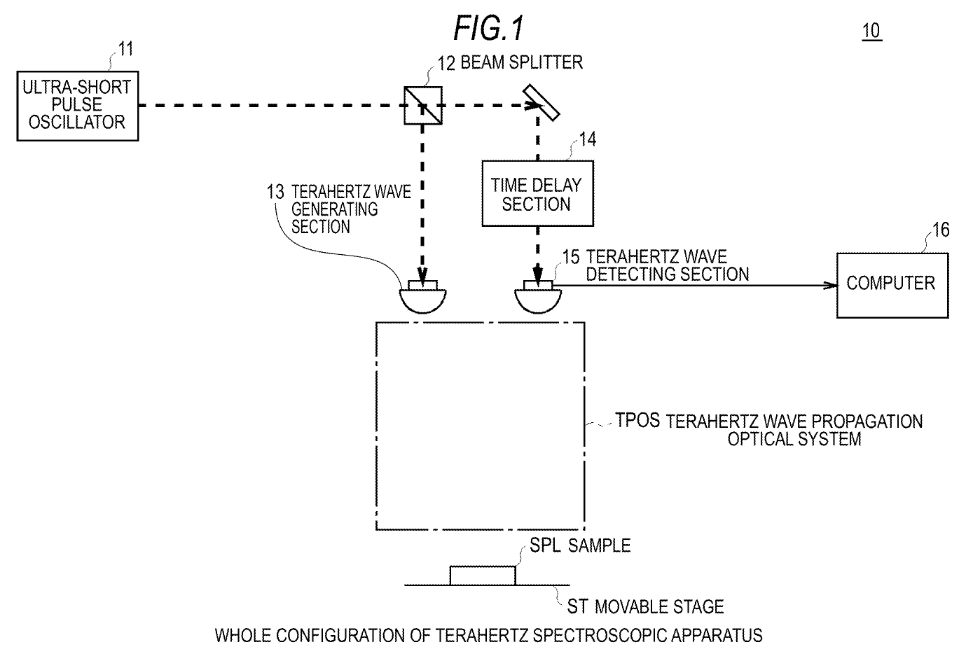

FIG. 1 shows the whole configuration of a terahertz spectroscopic apparatus 10 according to the present embodiment. The terahertz spectroscopic apparatus 10 includes an ultra-short pulse oscillator 11, a polarization beam splitter 12, a terahertz wave generating section 13, a time delay section 14, a terahertz wave detecting section 15 and a computer 16.

The ultra-short pulse oscillator 11 emits pulse light, for example, having a pulse width of approximately 60 fs, a repetition interval of approximately 100 MHz and a central wavelength of approximately 800 nm. Specifically, a femtosecond titanium sapphire pulse laser or a femtosecond fiber laser is applied as the ultra-short pulse oscillator 11.

The beam splitter 12 splits pulse light emitted from the ultra-short pulse oscillator 11 into pumping light and probe light. The pumping light is condensed at the terahertz wave generating section 13 through a given optical system. On the other hand, the probe light is led to the terahertz wave detecting section 15 through the time delay section 14 and a given optical system.

The terahertz wave generating section 13 generates terahertz waves having an electric field amplitude triggered by the pumping light. Specifically, for example, a photoconductive antenna including a semiconductor substrate made of semi-insulating GaAs and the like, a pair of electrodes formed on the semiconductor substrate and an application section which applies bias voltage to the electrodes is used as the terahertz wave generating section 13. It is also possible to apply an electro-optical crystal such as ZnTe which is used as a generation method of terahertz waves by difference frequency mixing.

The terahertz waves generated from the terahertz wave generating section 13 is led to a sample SPL disposed on a movable stage ST through a terahertz wave propagation optical system TPOS, and terahertz waves transmitted through the sample SPL or reflected by the sample SPL are condensed at the terahertz wave detecting section 15 through the terahertz wave propagation optical system TPOS.

The time delay section 14 delays arrival time of probe light with respect to the terahertz wave detecting section 15 (excitation timing with respect to the terahertz wave detecting section 15) by varying an optical path length between the polarization beam splitter 12 and the terahertz wave detecting section 15. Specifically, for example, a configuration in which a stage in which mirrors such as a retroreflector and a roof mirror are arranged is moved in a direction coming close to or in a direction moving away from a rectangular prism or the like at a prescribed speed is applied as the time delay section 14.

The terahertz wave detecting section 15 detects terahertz waves led through the terahertz wave propagation optical system TPOS after transmitted through the sample SPL or reflected by the sample SPL. That is, the terahertz wave detecting section 15 generates an electric field according to terahertz waves led through the terahertz wave propagation optical system TPOS, sampling the waveform of an oscillating electric field of terahertz waves at arrival timing of probe light delayed by the time delay section 14. As a specific example of the terahertz wave detecting section 15, the photoconductive antenna, electro-optical crystals such as ZnTe and the like can be applied in the same manner as the terahertz wave generating section 13.

The computer 16 obtains a waveform of the oscillation electric field of terahertz waves (hereinafter, referred to as a first terahertz waveform) measured by the terahertz wave detecting section 15 in a state in which a measurement target is arranged on an arrangement surface as the sample SPL and a waveform of the oscillation electric field of terahertz waves (hereinafter, referred to as a second terahertz waveform or a second detection signal) measured by the terahertz wave detecting section 15 in a state in which an object to be a measurement reference (for example, a metal mirror, a silicon substrate and the like) is arranged on the mounting surface as the sample SPL. The second detection signal may be stored in a storage section in the computer 16 and obtained from the storage section.

When the computer 16 obtains the first terahertz waveform and the second terahertz waveform, the computer 16 performs the Fourier transform to both terahertz waveforms and obtains a transmission spectrum and a reflection spectrum in a terahertz band to be a wide range based on the ratio of spectra obtained as the transform result. The computer 16 calculates a complex dielectric constant or an optical constant of the measurement target based on the spectrum and generates information concerning components, concentration, a state (form) and the like of the measurement target from the calculation result.

As described above, according to the terahertz spectroscopic apparatus 10, high S/N ratio in this frequency band can be obtained as compared with the Fourier spectroscopy using far-infrared light by applying the terahertz time-domain spectroscopy as well as amplitude information and phase information can be obtained simultaneously, as a result, the terahertz spectroscopic apparatus 10 can obtain information concerning the measurement target with high accuracy.

### (2) Configuration of Time Delay Section

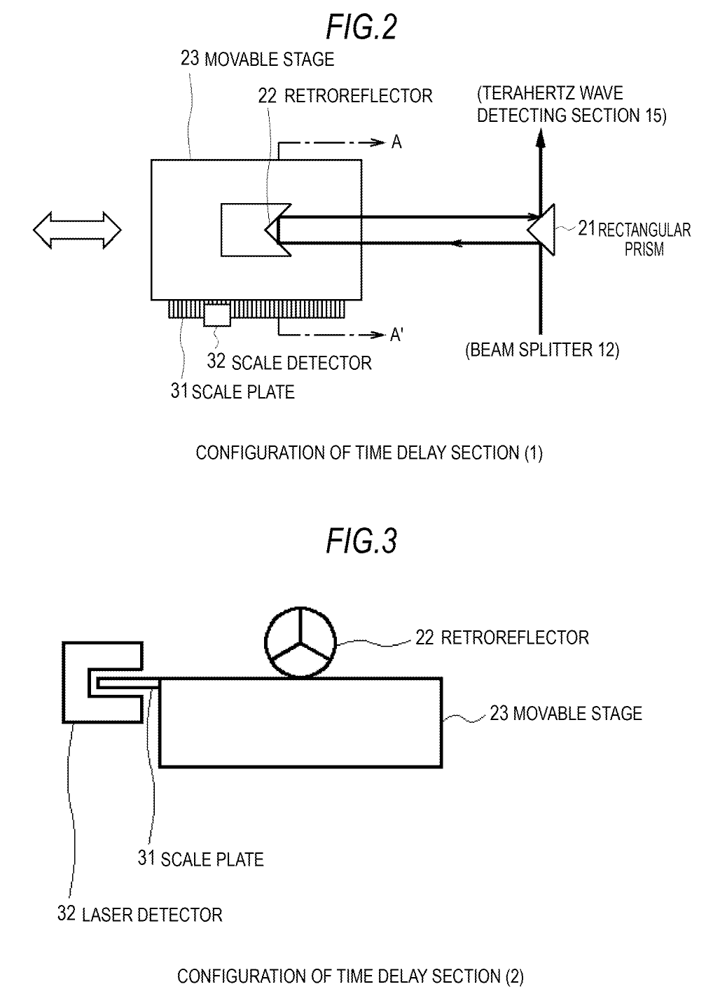

Next, a configuration of the time delay section 14 will be explained with reference to FIG. 2 and FIG. 3 in which A-A′ cross section in FIG. 2 is taken. The time delay section 14 includes a rectangular prism 21, a retroreflector 22 and a movable stage 23.

The rectangular prism 21 emits probe light which is incident on one reflection surface to a direction orthogonal to the incident direction and emits probe light which is incident on the other reflection surface to the direction which is the same direction as the incident direction of one reflection surface.

The retroreflector 22 is provided at the movable stage 23 in a state in which a return surface faces the rectangular prism 21, returning probe light incident from one surface of the rectangular prism 21 to the other surface of the rectangular prism 21.

The movable stage 23 is configured to move in a direction moving away from (incident direction) or coming close to (opposite direction of the incident direction) the rectangular prism 21 at a predetermined speed along an optical axis of pulse light incident from the rectangular prism 21.

At an end portion of the movable stage 23, a scale plate 31 having scale marks added at given intervals is provided in parallel to a moving direction of the movable stage 23, and the scale plate 31 is inserted into a detection area having a C-shape in a scale detector 32 fixed at a given position in a state of being parallel to a detection surface.

The scale detector 32 is configured to detect scale marks in the scale plate 31 passing through the detection surface by laser, outputting a pulse (hereinafter, referred to as a scale detection pulse) having a detection period of the scale mark as a rising edge (or a falling edge) to the computer 16.

Accordingly, in the time delay section 14, when the movable stage 23 moves in the direction moving away from the rectangular prism 21 from a start position which is the same length as the optical path length of the pumping light, a scale detection pulse having the number of rising edges corresponding to a moved amount from the start position and having intervals corresponding to the moving speed is outputted from the scale detector 32 into which the scale plate 31 provided at the movable stage 23 is inserted.

### (3) Configuration of Computer

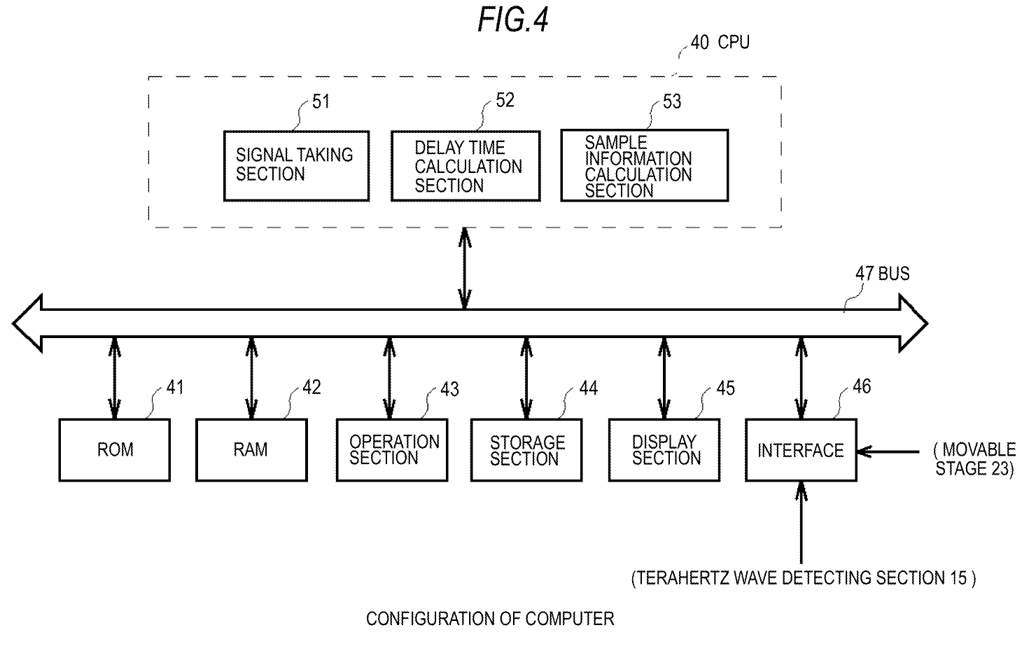

Next, a configuration of the computer 16 will be explained with reference to FIG. 4. The computer 16 is constructed by connecting a ROM (Read Only Memory) 41, a RAM (Random Access Memory) 42 as a work memory of a CPU (Central Processing Unit) 40, an operation section 43, a storage section 44, a display section 45 and an interface 46 with respect to the CPU 40 respectively through a bus 47.

The ROM 41 stores, for example, a measurement program for measuring the sample SPL. The terahertz wave detecting section 15 and the movable stage 23 are connected to the interface 46 through prescribed transmission lines respectively.

The CPU 40 is configured to execute various processing by suitably controlling the storage section 44, the display section 45 and the interface 46 based on the measurement program and instructions given from the operation section 43 according to need when the measurement program stored in the ROM 41 is developed in the RAM 42.

The CPU 40 which has developed the measurement program in the RAM 42 can be functionally classified into respective sections of a signal taking section 51, a delay time calculation section 52 and a sample information calculation section 53 as shown in FIG. 4.

The signal taking section 51 takes a signal outputted from the terahertz wave detecting section 15 as data (hereinafter, also referred to as detection data) by synchronizing the timing with the scale detection pulse outputted from the scale detector 32 in the time delay section 14.

That is, the signal taking section 51 is configured to quantize a value of the detected signal every time the scale mark in the scale plate 31 passing through the detection area of the scale detector 32 is detected by laser by the scale detector 32.

The delay time calculation section 52 calculates a time position of detected data on the terahertz waveform every time the detection data is taken from the signal taking section 51. Specifically, the time position means the excitation timing (delay time) of the terahertz wave detecting section 15 delayed by the time delay section 14. When the delay time is represented as “T”, a scale interval of scale marks added to the scale plate 31 is represented as Δx and the velocity of light in the air is represented as “c”, the delay time is calculated by the following formula.

$$T = \frac{Δ x}{c} \qquad ( 1 )$$

When the detection data in the signal taking section 51 is completed, the delay time calculation section 52 transmits respective detection data taken by the signal taking section 51 to the sample information calculation section 53 after associating the detection data with arrival time by adding arrival time with respect to the detection data or the like.

The sample information calculation section 53, when obtaining respective detection data given from the delay time calculation section 52, cuts a specific waveform portion in the terahertz waveform shown in these detection data if necessary by using arrival time associated with the detection data as a reference.

Then, the sample information calculation section 53 performs a FFT (Fast Fourier Transform) processing to the detection data of an obtaining target or a cutting target, thereby obtaining a spectrum in the terahertz waveform shown in the detection data and storing the spectrum in the storage section 44.

The sample information calculation section 53, when obtaining the spectrum in the terahertz waveform, calculates a transmission spectrum or a reflection spectrum based on the ratio with respect to the reference spectrum as well as calculates a complex dielectric constant or an optical constant of the measurement target to generate information concerning components, concentration, a state (form) and the like of the measurement target from the calculation result and store the information in the storage section 44.

### (4) Measurement Processing Procedure

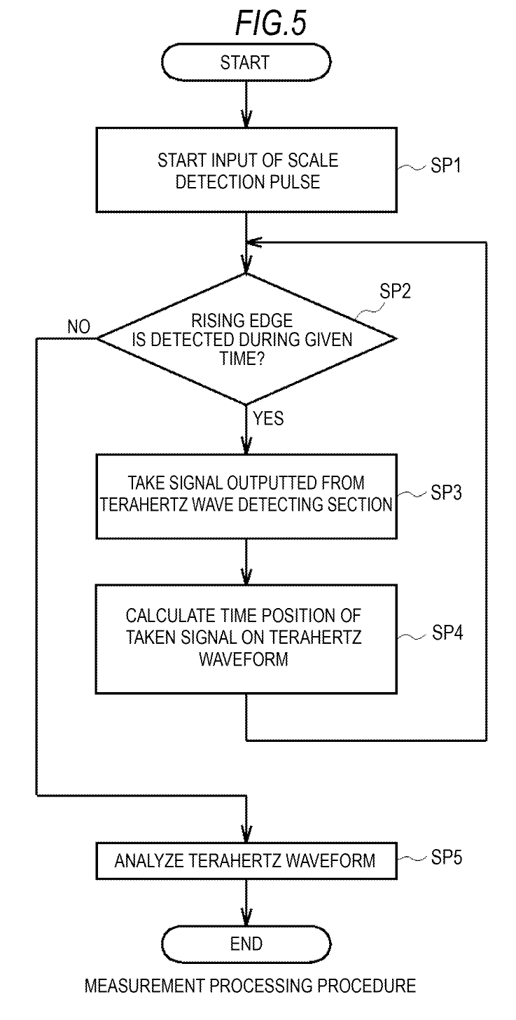

Next, a measurement processing procedure of the CPU 40 which has developed the measurement program in the RAM 42 will be explained with reference to a flowchart shown in FIG. 5. The CPU 40 starts the measurement processing procedure when, for example, a measurement instruction is given from the operation section 43, starting input of the scale detection pulse signal given from the scale detector 32 in Step SP1, and waiting a rising edge of the scale detection pulse in next Step SP2.

When the rising edge of the scale detection pulse is detected here, the CPU 40 proceeds to Step SP3, taking a signal outputted from the terahertz wave detecting section 15 as detection data, and calculating a time position of the detection data on the terahertz wave in next Step SP4, then, returning to Step SP2.

On the other hand, when the rising edge of the scale detection pulse is not detected after a prescribed time has passed, the CPU 40 recognizes that the measurement in the terahertz wave detecting section 15 has been completed, proceeding to Step SP5 and ending the measurement processing procedure after analyzing terahertz waveforms shown in respective detection data taken in the previous process.

As analysis of terahertz waveforms, specifically, the processing is performed, in which the specific waveform portion in the terahertz waveform is cut if necessary by using the time position associated to the detection data as a reference, and information concerning components, concentration, a state (form) and the like of the measurement target is generated based on the spectrum with respect to the terahertz waveform or the specific waveform portion and the information is displayed if necessary.

As described above, the CPU 40 which has read the measurement program in the RAM 42 is configured to execute measurement processing.

### (5) Operation and Effect

In the above configuration, the terahertz spectroscopic apparatus 10 takes signals outputted at pulse intervals of probe light from the terahertz wave detecting section 15 by synchronizing the timing with the scale detection pulse signal showing that the scale arranged equal intervals along the moving direction of the movable stage 23 has been detected from the scale detector 32.

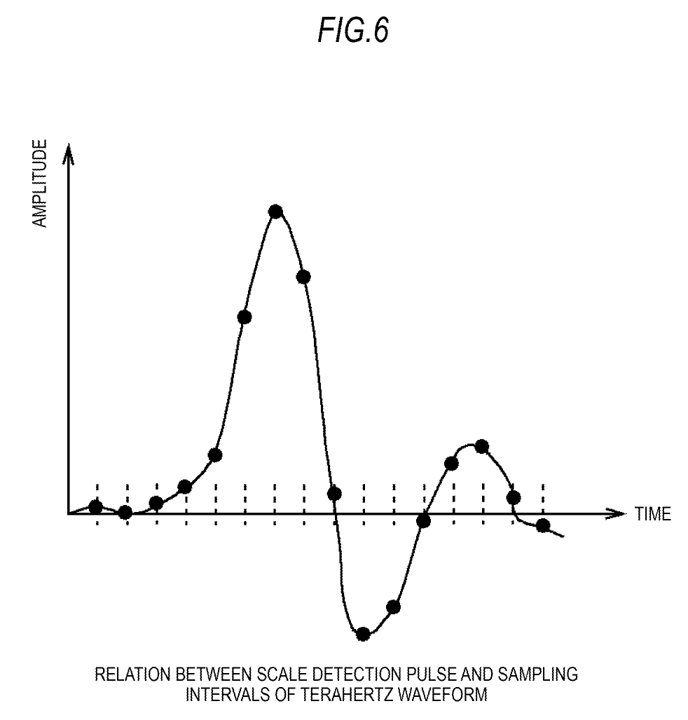

When the movable stage 23 is moved, the terahertz spectroscopic apparatus 10 takes detection signals in the terahertz wave detecting section 15 every time the stage passes through the scale according to the movement. Therefore, in the terahertz spectroscopic apparatus 10, it is possible to coordinate taking time based on the scale detection pulse signal (positions shown by dotted lines in the drawing) with sampling points of the terahertz waveform to be taken at the taking time (positions shown by black dots) regardless of the moving speed of the movable stage 23 as shown in FIG. 6.

In the above quoted document, the internal clock as the reference of taking signals outputted from the terahertz wave detecting section is fixed, whereas, the speed of the delay stage which delays arrival time of probe light for allowing the terahertz wave detecting section to detect a terahertz wave is not fixed on a mechanical configuration. The speed is accelerated at the beginning and is decelerated at the end as a rule.

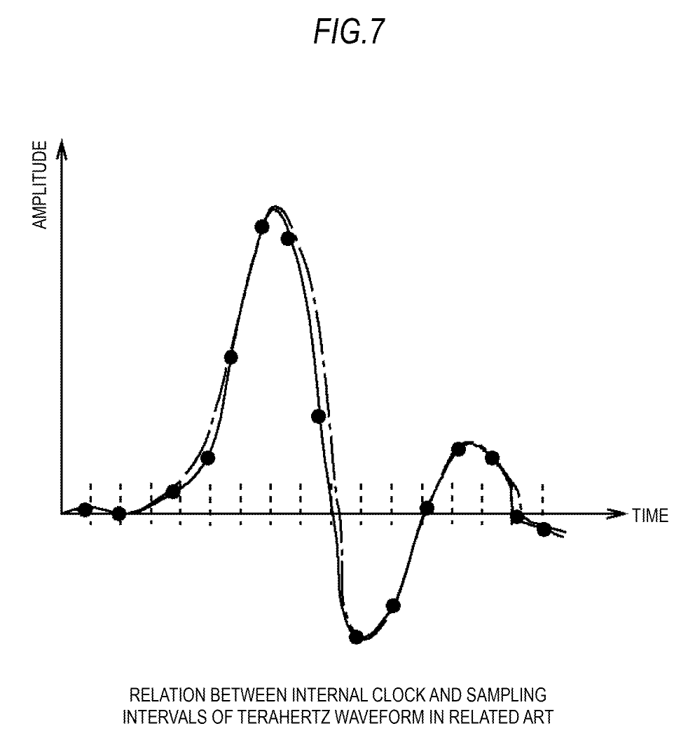

Accordingly, when there is the difference between speed of the delay stage at an initial operation and speed after the initial operation has passed, or accidental speed change such as cogging happens, the difference occurs between taking time based on the internal clock (positions shown by dotted lines in the drawing) and sampling points of the terahertz wave to be taken at the taking time (positions shown by black dots in the drawing) as shown in FIG. 7. Therefore, in the quoted document, correction processing with respect to the terahertz waveform is necessary based on positions of the delay stage, and the measurement accuracy of the terahertz waveform depends on a method of correction processing.

In the case that a voice coil motor stage of V-106.14s manufactured by Professional Instrument Company (stroke: 20 mm, maximum speed: 240 mm/s) is used as the movable stage 23 and a laser scale (output resolution: 0.05 μm) of BL-57-003REFC manufactured by Sony Manufacturing Systems Corporation is used as the scale plate 31 and the scale detector 32, the position accuracy in consideration of variations of marking pitch intervals can be less than 0.05 μm. Therefore, it is possible to realize the accuracy of sampling intervals of 0.17 fs.

Additionally, in the terahertz wave spectroscopic apparatus 10, every time a signal outputted from terahertz detecting section 15 at pulse intervals of probe light is taken, delay time in the signal (time position on the terahertz waveform) is calculated (Formula 1).

Since the delay time in each signal to be taken will be a reference when the terahertz waveform shown by the signal is analyzed in detail, in the terahertz wave spectroscopic apparatus 10, not only the spectrum concerning the whole terahertz waveform is calculated but also various signal analysis with respect to the terahertz waveform can be performed, such that the spectrum concerning part of the terahertz waveform is examined carefully or corrected, or the spectrum except part of the terahertz waveform is examined carefully.

Also since the movable stage 23 is moved in parallel to the optical axis of probe light in the terahertz wave spectroscopic apparatus 10, it is possible to suppress mechanical oscillation with respect to the movable stage 23 as compared with the case of taking moving manners other than translatory movement, which can reduce the lowering of measurement accuracy caused by the mechanical oscillation.

According to the above configuration, the detection signal by the terahertz wave detecting section 15 is taken every time the scale mark is detected by the scale detector 32 moving in conjunction with the movement of the movable stage 23, thereby allowing the sampling intervals of the terahertz waveform to be fixed regardless of moving speed of the stage, as a result, it is possible to realize the terahertz spectroscopic apparatus 10 which can improve measurement accuracy of the terahertz waveform without necessity of correction with respect to change of moving speed of the stage as in the quoted document.

### (6) Other embodiments

In the above embodiment, the case in which arrival time of probe light to the terahertz wave detecting section 15 is delayed by varying the optical path length of probe light is described, however, the invention is not limited to this, and it is also preferable that arrival time of probe light to the terahertz wave detecting section 15 is delayed by varying the optical path length of pulse light.

In the above embodiment, the case in which the retroreflector 22 is applied as a return mirror returning incident pulse light is described, however, the invention is not limited to this, and it is also preferable that a roof mirror is applied. It is not limited to the retroreflector 22 or the roof mirror as long as it is the one which returns incident pulse light, and the kind, the number, materials and the like of an optical component to be applied are no object.

In the above embodiment, the case in which the movable stage 23 which moves in parallel to the optical axis of probe light is applied is described, however, the invention is not limited to this, and movable stages in various moving manners can be applied as long as they are movable stages which can move in a direction in which the optical path length of pulse light or probe light is contracted or extended.

As a pattern of reciprocating movement (sweeping movement) in the contracting direction and the extending direction in the movable stage 23, various patterns can be applied. When the pattern of the reciprocating movement (sweeping movement) is regarded as a waveform, there are generally a triangular waveform, a trapezoidal waveform, a rectangular waveform, a sine waveform and the like, however, it is also possible to apply other optional waveform patterns.

In the above embodiment, the case in which the scale detector 32 fixed at the given position detects scale marks added to the scale plate 31 provided at the movable stage 23 is described, however, the invention is not limited to this, and it is also preferable that the scale detector 32 provided at the movable stage 23 detects scale marks added to the scale plate 31 fixed at the given position. Note that examples other than the shown example can be realized by outputting a pulse signal showing that scale marks arranged along the moving direction of the movable stage has been detected.

In the above embodiment, the case in which the signal taking section 51 by software is applied is described, however, it is also preferable that an A/D (Analog/Digital) converter by hardware is applied instead of the signal taking section 51.

The invention can be industrially utilized in industry, medical services, biotechnology, agriculture, security, information communications/electronics and so on.

The present application contains subject matter related to that disclosed in Japanese Priority Patent Application JP 2008-152047 filed in the Japan Patent Office on Jun. 10, 2008, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A method of measuring a terahertz wave comprising the acts of:
starting input of a pulse signal showing that scale marks have been detected, which are arranged at equal intervals along a moving direction of a movable stage which can move in a direction in which an optical path length of incident pulse light is contracted or extended; and
taking signals outputted at pulse intervals of the incident pulse light from a terahertz wave detecting section by synchronizing timing with the pulse signal.

2. The method of measuring terahertz waves, according to claim 1, further comprising the act of:
calculating a time position on a terahertz waveform in a signal taken in the taking act.

3. The method of measuring terahertz waves, according to claim 2, further comprising the act of:
cutting a specific waveform from the terahertz waveform shown in respective signals taken in the taking act based on time positions calculated in the calculating act.

4. The method of measuring terahertz waves, according to claim 2,
wherein the movable stage can move straight along an optical axis of the incident pulse light in an incident direction or an opposite direction to the incident direction.

5. A terahertz spectroscopic apparatus comprising:
a return mirror returning incident pulse light;
a movable stage in which the return mirror is disposed, which can move in a direction in which an optical path length of the pulse light is contracted or extended;
a terahertz wave detecting section detecting scale marks arranged at equal intervals along a moving direction of the movable stage and outputting a pulse signal showing that the scale marks have been detected; and
a signal taking section taking signals outputted at pulse intervals of the incident pulse light from the terahertz wave detecting section by synchronizing timing with the pulse signal.
